(19) United States
(12) Patent Application Publication
(10) Pub. No.: US 2008/0075975 A1
(43) Pub. Date: Mar. 27, 2008

(54) Magnetic cores for inductors and transformers and method of manufacture

(75) Inventors: John Stanley Glaser, Niskayuna, NY (US); Francis Johnson, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/526,915

(22) Filed: Sep. 26, 2006

(51) Int. Cl. B32B 15/04; B05D 5/12

(52) U.S. Cl. 428/693.1; 427/128

(57) ABSTRACT

A magnetic core includes a tape comprising a magnetic film disposed on a substrate. The tape is arranged in a winding having a number of turns to form the magnetic core. The magnetic film comprises a magnetic material characterized by a coercivity of less than about ten Oersteds (10 Oe). A transformer includes the magnetic core, and a number of electrically conductive windings, where each of the windings extends around the magnetic core in at least one turn. An inductor includes the magnetic core, and an electrically conductive winding extending around the magnetic core in a number of turns.

### STATEMENT REGARDING FEDERALLY SPONSORED RESEARCH & DEVELOPMENT

This invention was made with Government support under contract number FA8650-05-C-7201 awarded by the Defense Advanced Research Projects Agency (DARPA). The Government has certain rights in the invention.

### BACKGROUND

The invention relates generally to magnetic cores for inductors and transformers and, more particularly, to low-loss magnetic cores using thin film magnetic materials.

Magnetic cores are key components of many electrical circuits that incorporate inductors or transformers. Beneficially, magnetic cores permit a reduction in size of the inductors and transformers, as well as reducing the level of stray flux for a given amount of stored energy relative to either a non-magnetic core or in the absence of a core.

However, magnetic cores typically exhibit some amount of electrical conductivity, such that eddy currents begin to flow in the magnetic cores as the frequency of magnetic field variation increases. The eddy currents give rise to losses in the magnetic cores, thereby limiting the maximum practical frequency.

Accordingly, it would be desirable to provide magnetic cores for inductors and transformers that could operate with low eddy current losses at high frequencies. It would further be desirable to provide magnetic cores for inductors and transformers that increase efficiency and reduce component size.

### BRIEF DESCRIPTION

Briefly, one aspect of the present invention resides in a magnetic core that includes a tape comprising a magnetic film disposed on a substrate. The tape is arranged in a winding having a number of turns to form the magnetic core. The magnetic film comprises a magnetic material characterized by a coercivity of less than about ten Oersteds (10 Oe).

Another aspect of the present invention resides in a transformer that includes a substrate comprising a non-electrically conductive material. The transformer further includes a magnetic film disposed on the substrate. The magnetic film and the substrate form a tape, and the tape is arranged in a winding having a number of turns to form a magnetic core. The magnetic film comprises a soft magnetic material characterized by a coercivity of less than about ten Oersteds (10 Oe). The transformer further includes a number of electrically conductive windings. Each of the windings extends around the magnetic core in at least one turn.

Yet another aspect of the present invention resides in a method of forming a magnetic core. The method includes depositing a magnetic film on a substrate to form a tape. The magnetic film comprises a magnetic material characterized by a coercivity of less than about ten Oersteds (10 Oe). The method further includes wrapping the tape in a winding having a number of turns to form the magnetic core.

Another aspect of the present invention resides in an inductor that includes a substrate comprising a non-electrically conductive material. The inductor further includes a magnetic film disposed on the substrate. The magnetic film and the substrate form a tape, and the tape is arranged in a winding having a number of turns to form a magnetic core. The magnetic film comprises a soft magnetic material characterized by a coercivity of less than about ten Oersteds (10 Oe). The inductor further includes an electrically conductive winding extending around the magnetic core in a number of turns.

### DRAWINGS

These and other features, aspects, and advantages of the present invention will become better understood when the following detailed description is read with reference to the accompanying drawings in which like characters represent like parts throughout the drawings, wherein:

FIG. 1 schematically illustrates a magnetic tape;

FIG. 2 schematically depicts a magnetic core formed by winding the magnetic tape shown in FIG. 1;

FIG. 3 illustrates an example transformer embodiment;

FIG. 4 shows a portion of a barrier-protected transformer embodiment in cross-sectional view;

FIG. 5 illustrates an example toroidal inductor embodiment;

FIG. 6 schematically depicts a magnetic tape being wound around a mandrel to form a magnetic core; and

FIG. 7 illustrates a magnetic tape that includes strips of magnetic material separated by gaps.

### DETAILED DESCRIPTION

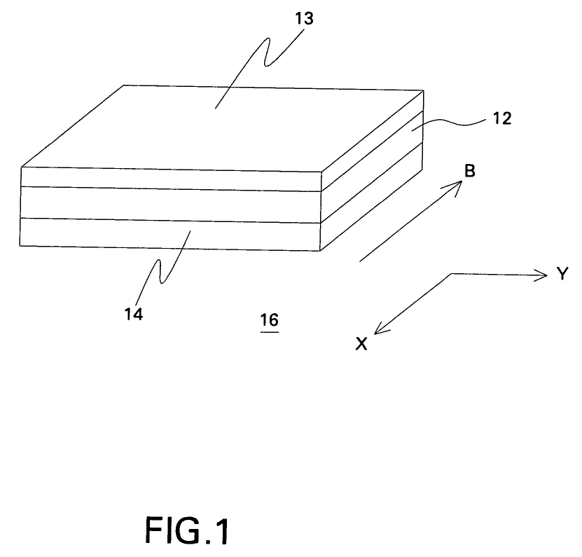

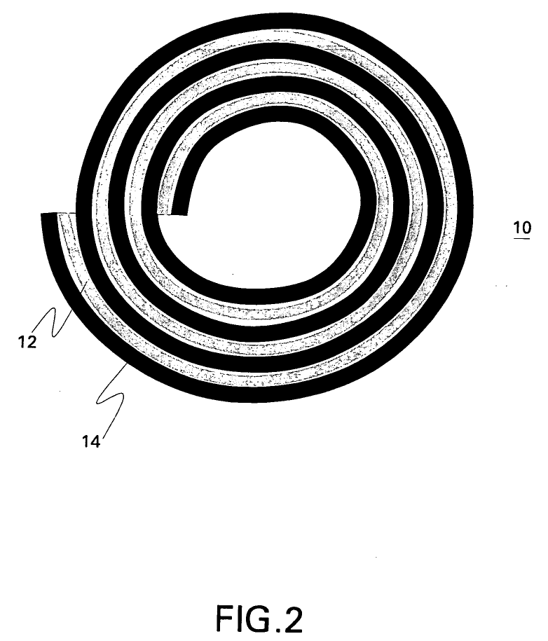

Embodiments of the invention directed to a magnetic core 10 for a transformer 20 or an inductor 30 are described with reference to FIGS. 1 and 2. As shown for example in FIG. 1, the magnetic core 10 includes a tape 16 comprising a magnetic film 12 disposed on a substrate 14. The magnetic material 12 may be deposited on all or on parts of the substrate 14. Thus, the magnetic film 12 may be continuous or segmented. The tape 16 is arranged in a winding comprising a number of turns to form the magnetic core 10. The magnetic film comprises a soft magnetic material characterized by a coercivity of less than about ten Oersteds (10 Oe). For the example embodiment depicted in FIG. 2, the tape 16 is spirally wound into a coil. By forming the core 10 in this manner, the cross-section of the core 10 is effectively subdivided into a number of smaller sections of magnetic material 12 that are separated by sections of electrically non-conductive material 14, so that the bulk core 10 has a laminated structure. This laminated structure increases the resistance to eddy current losses, thereby reducing eddy current losses and increasing the practical operating frequency for the core 10. In general, the smaller the dimensions of the magnetic material, the greater the reduction in eddy current losses and the higher the usable operating frequency will be.

For particular embodiments, the substrate 14 comprises a non-electrically conductive material, non-limiting examples of which include flexible organic polymers, such as polyimide, examples of which include materials marketed under the trade names Kapton® and Upilex®. Upilex® is commercially available from UBE Industries, Ltd., and Kapton® is commercially available from E. I. du Pont de Nemours and Company. Other exemplary flexible organic polymers include polyethersulfone (PES) from BASF, polyethyleneterephthalate (PET or polyester) from E. I. du Pont de Nemours and Company, polyethylenenaphthalate (PEN) from E. I. du Pont de Nemours and Company, and polyetherimide (PEI) from General Electric. PEI is commercially available from General Electric under the designation Ultem®. In other embodiments, the substrate 14 comprises flexible glass (fiber glass). Alternatively, the flexible substrate 14 may be partially or wholly removed after deposition of the magnetic film in order to increase the fraction of the tape comprised of magnetic film 12. Alternatively, the flexible substrate 14 may be formed of an electrically conductive material, where the substrate 14 is either removed after deposition of the magnetic film 12 or processed such that it becomes a poor electrical conductor, for example by oxidation. For particular embodiments, the substrate has a thickness in a range of about 1 micrometer to about 25 micrometers.

For the particular embodiment shown in FIG. 1, the tape further includes a non-magnetic capping layer 13 disposed over the magnetic film 12. More particularly, the non-magnetic capping layer 13 comprises an electrically insulating material.

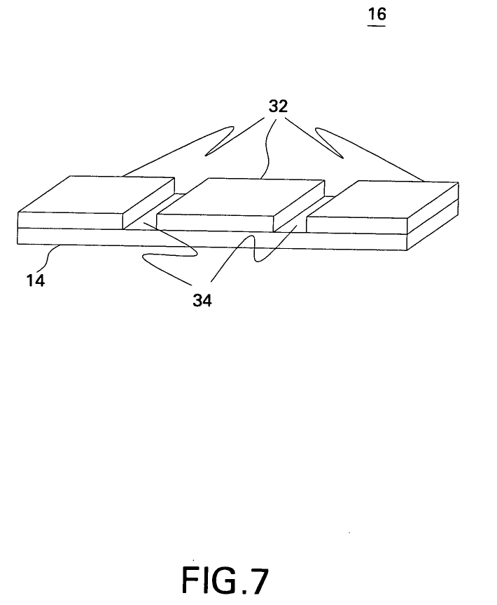

In particular embodiments, the tape is subdivided into a number of strips, as shown for example in FIG. 7. The strips may be formed by segmenting the tape, either before or after deposition of the thin magnetic film. Alternatively, the strips may be formed by etching through the magnetic film, while leaving the substrate in tact. For the example shown in FIG. 7, the strips 32 of magnetic material are separated by gaps 34. The gaps 34 may be filled with a non-magnetic material, including air. In this manner, the effective bulk permeability of the magnetic core 10 can be reduced with a small or negligible effect on the magnetic cross-sectional area. This allows control of the permeability with only a negligible effect on the effective saturation flux density of the core.

According to particular embodiments, the magnetic film has a magnetic anisotropy easy axis oriented substantially in the plane of the tape with a controlled angle relative to the longitudinal direction of the tape. For the example shown in FIG. 1, the plane of the tape is the x-y plane, and the longitudinal direction is the y-direction. By “substantially” it is meant that the anisotropy easy axis is controlled to be within plus or minus ten degrees of the required angle relative to the longitudinal direction of the tape. In a particular example, the anisotropy easy axis is a transverse easy axis, which is oriented at a ninety degree angle relative to the longitudinal direction of the tape, while remaining in the plane of the tape. In another example, the anisotropy easy axis is a longitudinal easy axis, which is oriented substantially parallel to the longitudinal direction of the tape, while remaining in the plane of the tape. The anisotropy easy axis determines the frequency at which the core resonates and also determines the magnetic permeability of the core. For particular embodiments, the magnetic film has a thickness in a range of about one micrometer to about ten micrometers (1−10×10⁻⁶ m). In particular embodiments, the magnetic material is characterized by a resistivity of at least about 1000 micro-Ohms/cm. Beneficially, a higher resistivity reduces eddy current losses, which are a major concern for magnetic inductors and transformers.

For certain embodiments, the magnetic material is a nano-granular material comprising nano-crystalline grains embedded in an electrically insulative matrix. As used here, “nano-crystalline grains” are characterized by a diameter in a range of about one nanometer (1 nm) to about twenty nanometers (20 nms) in diameter. In one non-limiting example, the nano-granular material comprises nano-crystalline cobalt grains embedded in a zirconium-oxide matrix. Typically, nano-granular materials are characterized by a saturation magnetization of at least about 8×10⁵ A/m (1 T/μₒ). Nano-granular magnetic films may be deposited on a variety of substrates, including without limitation, flexible organic polymers, such as polyimide, silicon nitride, glass, silicon, glassy carbon, sodium chloride, copper, and Gd₃Ga₂Ga₃O₁₂ (GGG) substrates. A variety of techniques may be used to deposit nano-granular magnetic films, non-limiting examples of which include electron beam physical vapor deposition (EB-PVD), powder pressing and/or sintering, sputtering, laser ablation, and evaporation. Exemplary sputtering techniques include RF magnetron, DC magnetron, and RF diode sputtering. Non-limiting examples of magnetic elements used in forming nano-granular magnetic materials include iron (Fe), cobalt (Co), nickel (Ni) and palladium (Pd). Non-limiting examples of reactive elements used in forming nano-granular magnetic materials include oxygen (O), nitrogen (N) and fluorine (F). Non-limiting examples of non-magnetic elements used in forming nano-granular magnetic materials include magnesium (Mg), tungsten (W), vanadium (V), titanium (Ti), tantalum (Ta), zirconium (Zr), niobium (Nb), hafnium (Hf), aluminum (Al), silicon (Si), boron (B) and rhenium (Re).

In other embodiments, the magnetic material comprises a ferrite. In one non-limiting example, the ferrite comprises nickel zinc ferrite.

In other embodiments, the magnetic material comprises an amorphous alloy. Non-limiting examples of amorphous alloys include iron based amorphous magnetic alloys, cobalt based amorphous magnetic alloys, iron-nickel based amorphous magnetic alloys and combinations thereof. Non-limiting examples of iron-based amorphous magnetic alloys include Magnetic Alloys 2605CO, 2605SA1, 2605S3A, 2605SC, which are distributed by Metglas®, Inc., Conway S.C. 29526. Non-limiting examples of cobalt-based amorphous magnetic alloys include Magnetic Alloy 2705M and 2714A, which are distributed by Metglas®, Inc. One non-limiting example of an iron-nickel based amorphous magnetic alloys is Magnetic Alloy 2826 MB, which is distributed by Metglas®, Inc.

In other embodiments, the magnetic material comprises a nano-crystalline alloy. Non-limiting examples of nano-crystalline alloys include iron-based nano-crystalline alloys, iron-cobalt-based nano-crystalline alloys, iron-silicon based nano-crystalline alloys and combinations thereof. Nano-crystalline soft magnetic materials are derived from crystallizing amorphous ribbons of specific families of (Fe,B)-based alloy chemistries. Nano-crystalline soft magnetic materials are characterized by 10-25 nm sized grains of a (bcc) (-(Fe,X) phase consuming 70-80% of the total volume, homogeneously dispersed in an amorphous matrix. Beneficially, nano-crystalline soft magnetic materials have low coercivities, high permeabilities, and exhibit low energy losses. One non-limiting example of an iron-silicon based nano-crystalline alloy is marketed under the tradename Finemet® and is distributed by Metglas® Inc, Conway S.C. 29526.

In other embodiments, the magnetic material comprises a crystalline alloy. Non-limiting examples of crystalline alloys include permalloy, silicon steel, permendur and combinations thereof. Permalloy is a nickel-iron magnetic alloy.

Beneficially, the deposition of the thin magnetic film 12 onto the substrate 14 enables use of the desirable magnetic properties of the thin magnetic films at power levels not practicable for the thin films by themselves. This is accomplished by providing a means for forming larger magnetic cores from multiple layers of the magnetic thin film.

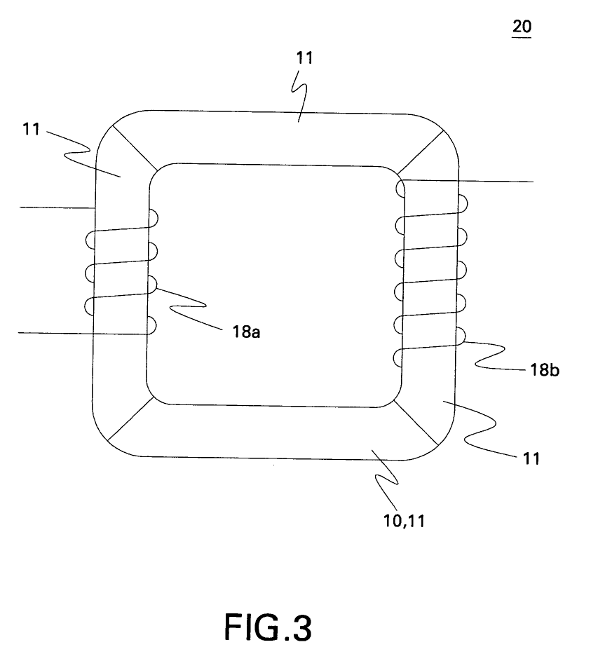

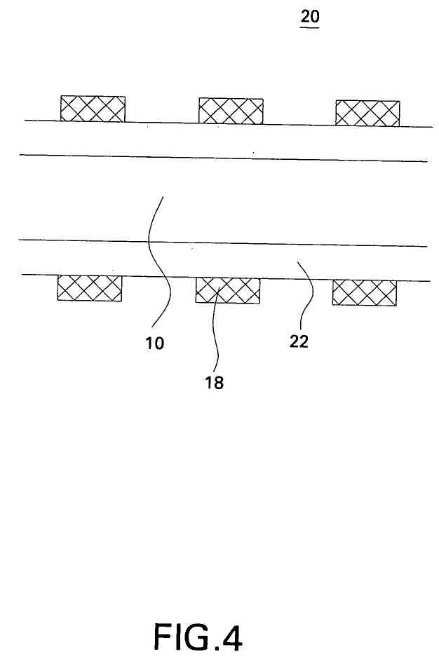

A transformer 20 embodiment of the invention is described with reference to FIGS. 1, 2, 3 and 4. The transformer 20 includes a magnetic core 10, which is illustrated in FIGS. 1 and 2. The transformer 20 includes a substrate 14 comprising a non-electrically conductive material. A magnetic film 12 is disposed on the substrate 14, the magnetic film 12 and the substrate 14 forming a tape 16, which is arranged in a winding having a number of turns to form a magnetic core 10, as shown for example in FIG. 2. The magnetic film comprises a soft magnetic material characterized by a coercivity of less than about ten Oersteds (10 Oe). The transformer 20 further includes electrically conductive windings 18, where each of the windings 18 extends around the magnetic core in at least one turn, as shown for example in FIG. 4. For the transformer shown in FIG. 3, there are two windings 18a and 18b.

For the embodiment shown in FIG. 4, the transformer 20 further includes a barrier layer or encapsulating structure 22 extending around the magnetic core 10 for protecting the magnetic core 10. In other embodiments (not shown), the windings 18 may be wound around the core 10, which is then encapsulated by layer 22. Nonlimiting examples of materials for forming barrier layer 22 include polymers, varnishes and epoxies.

For the example transformer illustrated in FIG. 3, the magnetic core 10 comprises a number of segments 11, where the segments are formed by cutting the wound core into sections. These sections may then be place adjacent to each other or they may be separated by a non-magnetic material, including air. In this manner, the effective bulk permeability of the magnetic core 10 can be reduced with a small or negligible effect on the magnetic cross-sectional area. This allows control of the permeability with only a negligible effect on the effective saturation flux density of the core. This also allows transformer or inductor windings to be wound on a bobbin and then slid over the core sections 11, which are then rejoined to form the complete core 10, with the advantage that the windings may be more economically formed separately from the core.

For particular embodiments of the transformer, the magnetic film has a magnetic anisotropy easy axis oriented substantially transverse to the longitudinal direction of the tape and in the plane of the tape. Namely, for these embodiments, the magnetic film has a transverse easy axis. For other embodiments of the transformer, the magnetic film has a longitudinal easy axis. Namely, for these latter embodiments, the magnetic film has a magnetic anisotropy easy axis oriented substantially parallel to the longitudinal direction of the tape and in the plane of the tape.

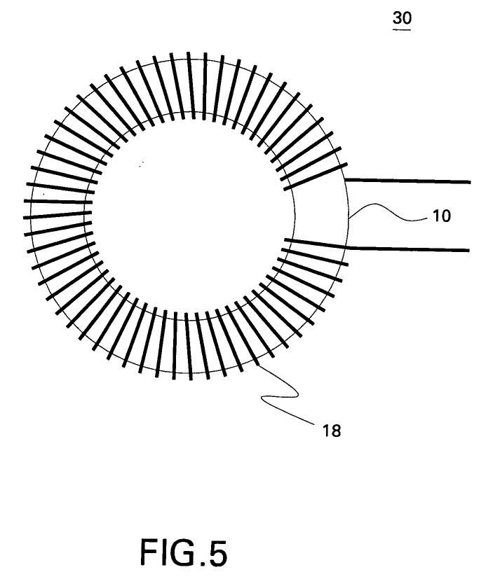

An inductor 30 embodiment of the invention is described with reference to FIGS. 1, 2 and 5. Although FIG. 5 depicts a toroidal inductor embodiment, the magnetic core 10 is equally applicable to other inductor configurations. As shown in FIG. 5, the inductor 30 includes a magnetic core 10, which is illustrated in FIGS. 1 and 2. The inductor 30 includes a substrate 14 comprising a non-electrically conductive material. A magnetic film is disposed on the substrate, the magnetic film and the substrate forming a tape 16, where the tape is arranged in a winding comprising a number of turns to form a magnetic core 10. The magnetic film comprises a soft magnetic material characterized by a coercivity of less than about ten Oersteds (10 Oe). The inductor 30 further includes an electrically conductive winding 18 extending around the magnetic core in a number of turns. The magnetic core 10 may be continuous or segmented.

In particular embodiments, the inductor 30 further includes a barrier layer or encapsulating structure extending around the magnetic core 10 for protecting the magnetic core. A barrier layer 22 is shown in FIG. 4 for a transformer embodiment.

For particular embodiments of the inductor, the magnetic film has a magnetic anisotropy easy axis oriented substantially transverse to the longitudinal direction of the tape and in the plane of the tape. Namely, for these embodiments, the magnetic film has a transverse easy axis. For other embodiments of the inductor, the magnetic film has a longitudinal easy axis. Namely, for these latter embodiments, the magnetic film has a magnetic anisotropy easy axis oriented substantially parallel to the longitudinal direction of the tape and in the plane of the tape.

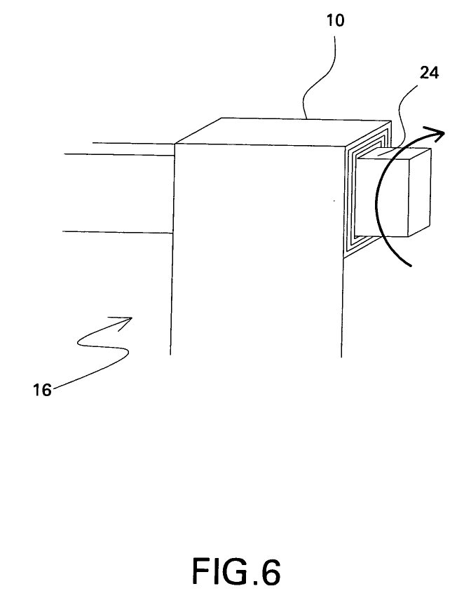

A method of forming a magnetic core 10 is described with reference to FIGS. 1, 2, and 3-6. The magnetic core may be used in inductor and transformer applications, as discussed above. A magnetic film 12 is deposited on a substrate 14 to form a tape 16. The magnetic film comprises a magnetic material characterized by a coercivity of less than about ten Oersteds (10 Oe). According to particular embodiments, the magnetic film 12 is deposited by sputtering or evaporating the magnetic material. Other deposition techniques include, but are not limited to, tapecasting and electrochemical deposition. For the particular embodiment illustrated by FIG. 1, the method further includes depositing a non-magnetic capping layer 13 over the magnetic film 12. More particularly, the non-magnetic capping layer 13 comprises an electrically insulating material. The tape is then wrapped in a winding comprising a number of turns to form the magnetic core 10. In particular embodiments illustrated by FIG. 6, the tape is wound around a mandrel 24 of desired cross-section to form the winding of desired size, and the mandrel 24 is removed from the magnetic core 10. Common mandrel shapes are round or rectangular, and other shapes may be used as well.

In certain embodiments, it is desirable to magnetize the film 12 during the deposition. For the example shown in FIG. 1 the method further includes applying a magnetic field oriented in a plane of the substrate and perpendicular to a longitudinal direction (y) of the substrate, where the magnetic field is applied during the deposition. For the example shown in FIG. 1, the magnetic field is oriented in the x direction. By depositing the magnetic film 12 in the presence of a magnetic field, the magnetic core 10 may have additional desirable properties, such as low hysteresis losses or a controlled permeability.

In particular embodiments, the method further includes annealing the magnetic core 10 after the wrapping step. For example, the core 10 may be heated to anneal the core. The specific annealing temperature will depend upon the specific materials used. For more particular embodiments, the method further includes exposing the magnetic core to an external magnetic field during the annealing step. For example, for the core shown in FIG. 2, a magnetic field would be oriented perpendicular to the plane defined by the figure during the anneal.

In particular embodiments, the method further includes subdividing the tape 16 into a number of strips, such that the strips are then wound in a winding to form the magnetic core 10. In certain embodiments, the tape 16 is subdivided into strips after the magnetic thin film 12 has been deposited onto the substrate 14. In other embodiments, the magnetic thin film 12 is deposited onto a number of pieces of the substrate 14 to form the strips. For the example shown in FIG. 7, the substrate is continuous, and the method further includes forming a number of gaps 34 in the magnetic film to subdivide the magnetic film into a number of strips 32 separated by gaps 32. In this manner, the effective bulk permeability of the magnetic core 10 can be reduced with a small or negligible effect on the magnetic cross-sectional area. This allows control of the permeability with only a negligible effect on the effective saturation flux density of the core.

To form a transformer, the method includes winding two electrically conductive windings 18 around the magnetic core, as indicated for example in FIG. 3. Similarly, to form an inductor, the method includes winding an electrically conductive winding 18 around the magnetic core, as indicated for example in FIG. 5. The windings can be wound, slid (in the case of a segmented core) or otherwise deposited on the core to form the transformer or inductor. To protect the core, the method further optionally includes forming a barrier layer 22 over the magnetic core 10 and the electrically conductive winding(s) 18, for particular embodiments. This embodiment is illustrated in FIG. 4. Nonlimiting examples of materials for forming barrier layer 22 include polymers, varnishes and epoxies. The barrier layer 22 may be deposited using a variety of techniques, nonlimiting examples of which include powder coating, spraying and dipping. In other examples, the core is placed in a mold (not shown), which is then filled with an encapsulant. In other examples, the core is placed in a container with the same (or similar) shape as the core but with slightly larger dimensions than the core. The container is then filled with soft or hard polymers or gels.

In particular embodiments, the method further includes segmenting the core to form a number of segments 11, and attaching the segments to form a segmented core 22, as indicated in FIG. 3 for a transformer embodiment.

As will be apparent to one skilled in the art, the above-described magnetic core has many applications in the processing of both small-signal and power circuits, non-limiting examples of which include magnetic energy storage and filtering in power processing applications, such as a switching power converter. In other non-limiting examples, the above-described magnetic core is used for electronic filtering of certain frequency ranges, as part of a sensor for detecting magnetic fields or as part of an anti-theft device.

The magnetic cores of the present invention provide several advantages including the ability to form larger magnetic core structures from thin film magnetic materials without compromising the magnetic properties of the thin films. Beneficially, the above-described magnetic cores are configured for operation with low eddy current losses at very high frequencies. In addition, the magnetic cores of the present invention increase circuit efficiency and reduce circuit size.

Although only certain features of the invention have been illustrated and described herein, many modifications and changes will occur to those skilled in the art. It is, therefore, to be understood that the appended claims are intended to cover all such modifications and changes as fall within the true spirit of the invention.

1. A magnetic core comprising:
a tape comprising a magnetic film disposed on a substrate, wherein the tape is arranged in a winding comprising a plurality of turns to form the magnetic core, wherein the magnetic film comprises a magnetic material characterized by a coercivity of less than about ten Oersteds (10 Oe).

2. The magnetic core of claim 1, wherein the substrate comprises a non-electrically conductive material, and wherein the substrate has a thickness in a range of about one micrometer to about twenty five micrometers.

3. The magnetic core of claim 1, wherein the magnetic film has a magnetic anisotropy easy axis oriented substantially parallel to a longitudinal direction of the tape and in a plane of the tape.

4-5. (canceled)

6. The magnetic core of claim 1, wherein the magnetic film has a thickness in a range of about one micrometer to about ten micrometers (1-10×10⁻⁶ m), and wherein the magnetic material comprises a material selected from the group consisting of:
a nano-granular material comprising a plurality of nano-crystalline grains embedded in an electrically insulative matrix;
a ferrite,
an amorphous alloy,
a nano-crystalline alloy,
a crystalline alloy and combinations thereof.

7. (canceled)

8. The magnetic core of claim 1, wherein the magnetic material is characterized by a resistivity of at least about 1000 micro-Ohms/cm.

9-14. (canceled)

15. The magnetic core of claim 1, wherein the tape is subdivided into a plurality of strips.

16. The magnetic core of claim 1, wherein the tape further comprises a non-magnetic capping layer disposed over the magnetic film.

17. The magnetic core of claim 1, wherein the substrate is continuous, wherein the magnetic film comprises a plurality of strips disposed on the substrate, and wherein the strips are separated by a respective plurality of gaps.

18. The magnetic core of claim 1, wherein the magnetic film has a magnetic anisotropy easy axis oriented substantially transverse to a longitudinal direction of the tape and in a plane of the tape.

19. A transformer comprising:
a substrate comprising a non-electrically conductive material;
a magnetic film disposed on the substrate, the magnetic film and the substrate forming a tape, wherein the tape is arranged in a winding comprising a plurality of turns to form a magnetic core, wherein the magnetic film comprises a soft magnetic material characterized by a coercivity of less than about ten Oersteds (10 Oe); and
a plurality of electrically conductive windings, wherein each of the windings extends around the magnetic core in at least one turn.

20. The transformer of claim 19, wherein the magnetic film has a thickness in a range of about one micrometer to about ten micrometers (1-10×10⁻⁶ m), and wherein the magnetic material is selected from the group consisting of:
a nano-granular material comprising a plurality of nano-crystalline grains embedded in an electrically insulative matrix,
an amorphous alloy,
a nano-crystalline alloy,
a crystalline alloy and combinations thereof.

21. (canceled)

22. The transformer of claim 19, further comprising a barrier layer extending around the magnetic core and the electrically conductive windings for protecting the magnetic core.

23. The transformer of claim 19, wherein the magnetic core comprises a plurality of segments.

24-25. (canceled)

26. A method of forming a magnetic core comprising:
depositing a magnetic film on a substrate to form a tape, wherein the magnetic film comprises a magnetic material characterized by a coercivity of less than about ten Oersteds (10 Oe); and
wrapping the tape in a winding comprising a plurality of turns to form the magnetic core.

27. (canceled)

28. The method of claim 26, further comprising applying a magnetic field oriented in a plane of the substrate and perpendicular to a longitudinal direction of the substrate, wherein the magnetic field is applied during the deposition.

29. The method of claim 26, further comprising:
annealing the magnetic core after the wrapping step; and
exposing the magnetic core to an external magnetic field during the annealing step.

30. (canceled)

31. The method of claim 26, further comprising:
disposing at least one electrically conductive winding a plurality of turns around the magnetic core to form one of a transformer or an inductor and
forming a barrier layer over the magnetic core and the electrically conductive winding.

32. (canceled)

33. The method of claim 26, further comprising segmenting the core to form a plurality of segments, and attaching the segments to form a segmented core.

34. (canceled)

35. The method of claim 26, further comprising subdividing the tape into a plurality of strips, wherein the wrapping step comprises wrapping the strips in the winding to form the magnetic core, and wherein the subdividing step is performed after the depositing step.

36. (canceled)

37. The method of claim 35, further comprising subdividing the tape into a plurality of strips, wherein the wrapping step comprises wrapping the strips in the winding to form the magnetic core, and wherein the subdividing step is performed prior to the depositing step such that the substrate is subdivided prior to depositing the magnetic film thereon.

38. (canceled)

39. The method of claim 26, wherein the substrate is continuous, the method further comprising forming a plurality of gaps in the magnetic film to subdivide the magnetic film into a plurality of strips separated by respective ones of the gaps.

40. An inductor comprising:
a substrate comprising a non-electrically conductive material;
a magnetic film disposed on the substrate, the magnetic film and the substrate forming a tape, wherein the tape is arranged in a winding comprising a plurality of turns to form a magnetic core, wherein the magnetic film comprises a soft magnetic material characterized by a coercivity of less than about ten Oersteds (10 Oe); and
an electrically conductive winding extending around the magnetic core in a plurality of turns.

41. The inductor of claim 40, wherein the magnetic film has a thickness in a range of about one micrometer to about ten micrometers (1-10×10⁻⁶ m), and wherein the magnetic material is selected from the group consisting of:
a nano-granular material comprising a plurality of nano-crystalline grains embedded in an electrically insulative matrix,
an amorphous alloy,
a nano-crystalline alloy,
a crystalline alloy and combinations thereof.

42. (canceled)

43. The inductor of claim 40, further comprising a barrier layer extending around the magnetic core and the electrically conductive winding for protecting the magnetic core.

44. The inductor of claim 40, wherein the magnetic core comprises a plurality of segments.

45-46. (canceled)
